(19) United States
(12) Patent Application Publication
(10) Pub. No.: US 2017/0129817 A1
(43) Pub. Date: May 11, 2017

(54) COMPACT METAL OXIDE BLOCK AND RELATED MANUFACTURING METHOD

(71) Applicant: EUROTAB, ST JUST ST RAMBERT (FR)

(72) Inventors: Christian COENRAETS, LE VESINET (FR); Christophe DUPONT, ST JUST ST RAMBERT (FR); Laurent KIRCHHOFF, ST JUST ST RAMBERT (FR)

(21) Appl. No.: 15/305,625

(22) PCT Filed: Apr. 22, 2015
(86) PCT No.: PCT/EP2015/058721

§ 371 Date: Oct. 20, 2016

(30) Foreign Application Priority Data
Apr. 22, 2014 (FR) 1453619

(51) Int. Cl. C04B 37/00; C04B 35/26; C04B 35/626; C04B 35/01

(52) U.S. Cl. CPC C04B 37/001; C04B 35/016; C04B 35/26; C04B 35/62605; C04B 2235/3267; C04B 2235/3272; C04B 2235/604; C04B 2235/72; C04B 2237/34

(57) ABSTRACT

The invention relates to a composition consisting of a mixture of one or more metal oxides having the formula MxOyUi, in which M is a metal atom selected from among iron, aluminum, titanium, manganese, zinc, copper, zirconium, nickel, and lead, O is an oxygen atom, U is an impurity, and x, y, and i are mole fractions comprised between 0 and 1, with x+y>80%, said composition taking the form of a three-dimensional compacted tablet having an apparent density greater than or equal to 2, an apparent porosity comprised between 3% and 40%, and a diametral breaking strength greater than or equal to 250 kPa.

The invention also relates to a method for manufacturing a compacted tablet comprising one or more metal oxides

### FIELD OF THE INVENTION

The present invention relates to compact metal oxide based products as well as the manufacture of such compact metal oxide based products, notably enabling the recycling of wastes and by-products from industry, for example the iron and steel industry.

### STATE OF THE PRIOR ART

Some industries, and in particular the iron and steel industry, are experiencing strong growth, with larger and larger productions, and generation of industrial wastes which is thus also increasing. Such industrial wastes are often stored in bulk, which harms the environment and generates costs, thus pushing industry to reclaim them.

Metal oxide based wastes are particularly interesting to recycle since they can be re-used in numerous industries, such as for example in the iron and steel industry, in the treatment of gases, in the treatment of water and sludge, in agriculture, in construction and in civil engineering. Such metal oxide based compounds can be used directly in the form of fines, fines being particles of size generally less than 10 mm and typically less than 6 mm, but their handling and their storage are not easy. Thus, industry favors metal oxide based products in condensed and solid form.

For example in the iron and steel or metallurgical industries, metal oxide compounds are easily reusable if they are in compact form, which is why it is customary to resort to the agglomeration of the fines of metal oxide compounds in order to increase the size and the density thereof.

Equipment and technologies exist which make it possible to take in charge, collect and treat the fines of metal oxide compounds. Nevertheless, the shaping of these fines into products in condensed and solid form, which facilitates their treatment and their recycling, is more problematic.

In this respect, a certain number of different techniques have been developed but none is at present really satisfactory, notably because it is complex to implement, involving in particular an important number of manufacturing steps, and/or because it requires the use of additional products to form these condensed and solid products, said additional products often adversely affecting the recycling as such of metal oxide compounds. For example, they can raise problems of compatibility with the final application of the condensed product.

Among techniques for shaping these fines may be cited pelleting, either hot or cold. Pelleting requires that the base material is finely ground until most of the ground particles have a centered particle size distribution, and compatible with this shaping method, typically less than 1 millimeter, and in general of the order of several micrometers. This method also necessitates resorting to additives and/or binders, which imposes drying operations, and which above all adversely affect the final use of the product. In addition, on account of the low mechanical strength of the pellets and the considerable friability thereof, this method again generates fines, which also adversely affect the final use. Moreover, such a method is costly, this cost not being able to justify the use of such a recycling method on an industrial scale on account of the drawbacks which are moreover associated therewith.

Another manufacturing technique, called briquetting, consists in manufacturing briquettes by compacting fines on a tangent roller press. The rollers are generally cylinders equipped with cavities forming molds corresponding substantially to the shape and the dimensions desired for the briquette. The manufacture of briquettes by tangent press enables powders generally not requiring additional grinding to be dealt with, with greater dimensions than for pelleting, in general of several millimeters. However, it is once again necessary that the majority of the particles to be compacted have a particle size distribution centered on a determined value and that there is no important particle size difference. Moreover, the addition of binding additives is also inevitable and in much greater quantity to that used in pelleting. These additives adversely affect the final use of the product notably in the field of steel manufacturing. Furthermore, these briquettes have to undergo specific additional treatments in order to increase their hardness and improve their mechanical properties. In addition to the inherent complexity of this method for manufacturing, it generates in itself an important level of waste since there is notably a loss of the composition to be compacted at the level of the air gap.

Apart from the aforementioned drawbacks, and apart from using an important quantity of binders, pelleting and briquetting methods do not make it possible to form products having sufficient mechanical strength, to be able notably to transport and handle these products without generating fines and dusts, that is to say without degrading them. Generally speaking, it is the presence of macro-defects in these products, notably briquettes, which is behind these less good mechanical properties. Macro-defect is taken to mean any type of fissure, crack, cleavage plane and analogous observable with the naked eye, by visual inspection or by simple microscopy and also by scanning electron microscopy (SEM). On account of the low quality of the compacts formed by these methods, it is estimated that the yield of pelleting and briquetting methods is below 50% as long as there are compacts that cannot be used at the outcome of these methods.

As has been indicated, known pelleting and briquetting methods necessitate additives for increasing the strength and the durability of metal oxide based products, these additives being for example bitumen, tar, sodium silicate or instead alcohol sulfite residues. Apart from the fact that this addition of additives is generally not sufficient as such to improve correctly the mechanical strength of the product, they adversely affect the later use of the product, notably being able to lead to a chemical reaction with the metal oxides present.

The documents U.S. Pat. No. 4,917,723 and EP 2 298 941 illustrate examples of manufacture of such condensed products with complex methods, notably necessitating grinding of the particles before being able to form the condensed product. It is moreover necessary to combine the iron oxide compounds with other materials so that the product can be formed, so that it remains cohesive and so that it has satisfactory strength for its handling. The documents DE 24 18 555, DE 24 31 983 or EP 0 466 160 also describe examples of techniques of shaping fines of metal oxide compounds, which obligatory necessitate resorting to binders so that the product formed has sufficient cohesion to be able to be handled.

An aim of the present invention is to propose a method for manufacturing metal oxide based tablets that solves at least one of the above drawbacks, and a novel condensed metal oxide based product.

In particular an aim of the present invention is to propose a compact product containing one or more metal oxide compounds and distinguishable from products in the form of briquettes and pellets known to date by a very clear improvement in mechanical strength.

Another aim of the present invention is to propose a simplified method of manufacturing a compact metal oxide based product which has enhanced mechanical strength. Advantageously, the proposed method moreover enables a production meeting industrial cadences.

### DESCRIPTION OF THE INVENTION

To this end, a composition is proposed consisting of a mixture of one or more metal oxides of formula MxOyUi, in which M is a metal atom selected from poor metals and transition metals, preferably with the exclusion of chromium, O is an oxygen atom, and U is an impurity, where x, y, i are mole fractions comprised between 0 and 1 with x+y>80%, said composition taking the form of a three-dimensional compacted tablet having an apparent density greater than or equal to 2, an apparent porosity comprised between 3% and 40%, and a diametral breaking strength greater than or equal to 250 kPa.

Preferred but non-limiting aspects of this composition, taken alone or in combination, are the following:
the composition is formed of a single type of metal oxide.
the metal oxides are in the form of particles having a diameter d90 less than or equal to 3 mm.
the metal M is selected from iron, aluminum, titanium, manganese, zinc, copper, zirconium, nickel and lead.
the composition consists of a mixture of iron oxide, a mixture of aluminum oxide, a mixture of titanium oxide, a mixture of manganese oxide, a mixture of zinc oxide, a mixture of copper oxide, a mixture of zirconium oxide, a mixture of lead oxide, or a mixture of at least two of the metal oxides cited above.
the composition has a drop test resistance less than 15%, preferably less than 10%, and even more preferably less than 5%.
the compacted tablet has an apparent porosity comprised between 5% and 30%, and preferably comprised between 10% and 25%.
the composition consists of a mixture of manganese oxide only, said composition taking the form of a three-dimensional compacted tablet having an apparent density comprised between 2 and 5, preferably comprised between 2.8 and 4.2.
the composition consists of a mixture of iron oxide only, said composition taking the form of a three-dimensional compacted tablet having an apparent density comprised between 2 and 5 preferably comprised between 2.8 and 4.4.
the composition consists of a mixture of manganese oxide in a quantity greater than 50% by weight with a mixture of one or more other types of metal oxide.
the composition consists of a mixture of iron oxide in a quantity greater than 50% by weight with a mixture of one or more other types of metal oxide.
the metal oxides are in the form of particles having diameters according to a random particle size distribution in which the ratio between the equivalent diameters of the particles of largest size and smallest size is greater than 50.

A compacted product having a multilayer structure is also proposed, where each layer forming the multilayer structure is a compacted tablet as proposed.

A method is moreover proposed for manufacturing a compacted tablet based on one or more metal oxides with a rotary punch press, including the following steps:
E1. Taking a composition consisting of a mixture of one or more metal oxides of formula MxOyUi, in which M is a metal atom selected from poor metals and transition metals, preferably with the exclusion of chromium, O is an oxygen atom, and U is an impurity, where x, y, i are mole fractions comprised between 0 and 1 with x+y>80%;
E2. Placing said composition in a confined space between two punches;
E3. Compaction of said composition by bringing together the punches and exerting a compaction stress on the composition in order to form a three-dimensional compacted tablet;
E4. Relaxation of the compaction stress by moving apart the punches.

Preferred but non-limiting aspects of this composition taken alone or in combination, are the following:
at step E3 of compaction, the compaction stress consists in applying a determined compaction pressure on the composition, the compaction pressure being comprised between 100 MPa and 800 MPa, preferably comprised between 200 MPa and 650 MPa, more preferentially comprised between 300 MPa and 500 MPa, and even more preferentially comprised between 350 MPa and 450 MPa.
at step E3 of compaction, the compaction stress consists in maintaining the composition at a determined compaction volume for a determined duration, the compaction volume being maintained for a duration comprised between 100 ms and 5000 ms, and preferably comprised between 500 ms and 1000 ms.
the metal oxide particles of step E1 are taken directly from among industrial metal oxide wastes without prior treatment.
at step E1, a composition is taken including particles of a single type of metal oxide.
at step E1, a composition is taken consisting of a mixture of manganese oxide only.
at step E1, a composition is taken consisting of a mixture of iron oxide only.
the metal oxide particles of step E1 are in the form of particles having a random particle size distribution.
the metal oxide particles of step E1 have diameters such that the ratio between the equivalent diameters of particles of largest size and smallest size is greater than 50.
in which the metal oxide particles of step E1 are in the form of particles having a diameter d90 less than or equal to 3 mm.

According to a preferred aspect, the method described is used for the manufacture of a compacted product having a multilayer structure, in which each layer forming the multilayer structure is formed by carrying out successively steps E1, E2, E3 and E4, where each new layer is formed on the tablet compacted at the preceding step.

The specific manufacturing process may for example be the following:
A first layer is formed by carrying out steps E1, E2, E3 and E4 with a first composition to create a first compacted tablet;
An additional layer is formed by carrying out steps E1, E2, E3 and E4 where:
   At step E1, an additional composition is taken consisting of a mixture of one or more metal oxides;
   At step E2, the additional composition is placed in the confined space between two punches on the first compacted tablet;
   At step E3, the additional composition and the first compacted tablet are compacted by bringing together the punches and exerting a compaction stress on the composition in order to form an additional compacted tablet on the first compacted tablet;
The formation of an additional layer is reiterated as a function of the number of layers desired in the compacted multilayer product.

### DESCRIPTION OF THE FIGURES

Other characteristics and advantages of the invention will become clearer from the description that follows, which is purely illustrative and non-limiting and which must be read with regard to the appended drawings, in which:

FIG. 1 is an SEM image (acronym of scanning electron microscopy) enlarged 40 times, illustrating the surface of a briquette of Fe3O4 formed according to a method of the prior art;

FIG. 2 is an SEM image enlarged 40 times, illustrating the surface of a compacted tablet of Fe3O4 formed according to the method of the invention;

FIG. 3 is an SEM image enlarged 40 times, illustrating the interior of a briquette of Fe3O4 formed according to a method of the prior art;

FIG. 4 is an SEM image enlarged 40 times, illustrating the interior of a compacted tablet of Fe3O4 formed according to the method of the invention;

FIG. 5 is an SEM image enlarged 80 times, illustrating the interior of a briquette of Fe3O4 formed according to a method of the prior art;

FIG. 6 is an SEM image enlarged 80 times, illustrating the interior of a compacted tablet of Fe3O4 formed according to the method of the invention;

FIG. 7 is an SEM image enlarged 40 times, illustrating the surface of a briquette of MnO formed according to a method of the prior art;

FIG. 8 is an SEM image enlarged 40 times, illustrating the surface of a compacted tablet of MnO formed according to the method of the invention;

FIG. 9 is an SEM image enlarged 40 times, illustrating the interior of a briquette of MnO formed according to a method of the prior art;

FIG. 10 is an SEM image enlarged 40 times, illustrating the interior of a compacted tablet of MnO formed according to the method of the invention.

### DETAILED DESCRIPTION OF THE INVENTION

It is proposed to implement an innovative method of compaction making it possible to manufacture a novel compact product formed only from metal oxide compounds.

In fact, the compact product that is formed has the particularity of being a compacted tablet consisting of a mixture of one or more metal oxides, that is to say including only metal oxide compounds with the exclusion of other compounds, in particular with the exclusion of binders or carbon-containing compounds.

Compacted tablet is taken to mean a compact product of three-dimensional shape having specific characteristics notably in terms of porosity, density and strength, chosen to enable simple handling of the product, and storage during which the product does not degrade or degrades little.

The compacted tablets may have various three-dimensional shapes such as a cylindrical, octagonal, cubic, rectangular, or spherical shape for example.

Each metal oxide of the composition meets the formula MxOyUi, in which:
M is a metal atom selected from poor metals and transition metals, preferably with the exclusion of chromium,
O is an oxygen atom,
U is an impurity, and
where x, y, i are mole fractions comprised between 0 and 1 with x+y>80%.

Preferably, the metal oxide is such that x+y>85%, or x+y>90%, or x+y>95%, or instead x+y>99%.

Transition metal designates a chemical element of block d of the periodic table (Mendeleev's table) which is neither a lanthanide nor an actinide. In the transition metals excluding chromium, it is thus possible to select from: scandium (Sc), titanium (Ti), vanadium (V), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), meitnerium (Mt), darmstadtium (Ds), roentgenium (Rg), copernicium (Cn).

Poor metal designates a chemical element of the p block of the periodic table. In poor metals, it is thus possible to select from: aluminum (Al), gallium (Ga), indium (In), tin (Sn), thallium (TI), lead (Pb), bismuth (Bi), polonium (Po), flerovium (FI).

Among these metal oxides may be cited in particular iron oxides, aluminum oxides, titanium oxides, manganese oxides, zinc oxides, copper oxides, zirconium oxides, lead oxides.

In the preceding formula, the impurity U is defined as a compound present in the metal oxide which has not been voluntarily introduced into said metal oxide. In particular, the impurity U may be due to the geology of the metal oxide. Generally speaking, the impurities U represent a mole fraction of less than 5% of the compound.

So-called pure metal oxides could for example be used, that is to say where the mole fraction i of impurity U is less than 1%.

The impurities U that can be present in the metal oxide of the tablet may be classified into three categories: organic, metal or particulate impurities. These impurities may be of molecular, ionic or atomic nature.

The following may for example be cited:
as particulate impurities: particles of silica, aluminosilicate type clays, ashes and flue gases;
as metal impurities: calcium, nickel, magnesium, gold, hydroxides of these same oxides, etc. at a level of 10¹⁰ atoms/cm² of oxide;
as organic impurities: sulfides and carbonates of these oxides. When the impurity U is metal, it is different from the metal M.

Particular and non-limiting examples of metal oxides that can be compacted according to the proposed method are the following: Fe₂O₃/Fe₃O₄/MnO/TiO₂/Al₂O₃/ ZnO/Fe(₁₋ₓ)S.Fe(OH)₂/Zn₄Si₂O₇(OH)₂, H₂O.

The compounds used to manufacture the compacted tablet may for example be wastes and by-products coming from industry, for example the iron and steel industry, and/or be natural products coming for example from mines or quarries.

These compounds to be compacted generally come in the form of particles but may also be in the form of rocks. In fact, one of the important advantages of the method implemented is that it makes it possible to produce compacted products from particles having a wide particle size distribution, and that it is thus not necessary to have particles having a particle size centered on a particular value as is the case for methods of the prior art.

In a preferred manner, it is possible to form the compacted tablet from metal oxide particles ranging from several micrometers to several millimeters, for example a wide particle size distribution spread out between 15 μm and 6 mm. Particles having a narrower particle size distribution, for example comprised between 40 μm and 3 mm or 40 μm and 1 mm, could be compacted.

In an advantageous form of embodiment, the particles of metal oxide composition have before compacting a diameter d₉₀ less than or equal to 3 mm. d₉₀ is taken to mean that 90% of the population of the particles have a size less than the diameter cited previously.

According to an additional example, the particles of metal oxide composition have preferably before compacting a diameter d₁₀ less than or equal to several tens of micrometers, for example less than 20 μm. d₁₀ is taken to mean that 10% of the population of the particles have a size less than the diameter cited previously.

The compacted tablet may consist of compounds of a single type of metal oxide, or be a mixture of several different metal oxides.

These compacted tablets may be mono- or multilayers, each layer being exclusively formed of one or more compounds of metal oxides compacted together.

Multilayer tablets offer certain advantages. They make it possible to isolate within a same solid structure compounds incompatible with each other from a physical/chemical viewpoint and/or to sequence over time the action of certain compounds (releasing an active ingredient at a different moment or place: role in the reaction kinetic).

As has been specified above, the compacted tablet has characteristics favoring its handling and its storage, as well as its later re-use with a view to recycling of metal oxides notably.

Thus, the compacted tablet has an apparent density greater than or equal to 2, preferably greater than 2.8, more preferentially greater than 3.

The apparent density is known from the apparent volumic mass of the tablet, that is to say the ratio between the mass of the tablet with respect to its apparent volume (including the volume of interstitial air), which is compared to the volumic mass of water (1 g/cm3).

Thus, the compacted tablet has an apparent volumic mass greater than or equal to 2 g/cm3, preferably greater than 2.8 g/cm3, more preferentially greater than 3 g/cm3.

According to an embodiment, the composition consists of a mixture of manganese oxide only. Such a composition may be formed from a single type of manganese oxide, or several different types of manganese oxide. The manganese oxide(s) are for example selected from: MnO, MnO2, Mn2O3, Mn2O7.

In this case, said manganese oxide based composition shaped into a three-dimensional compacted tablet has an apparent density comprised between 2 and 5, and preferably comprised between 2.8 and 4.2.

To form such a tablet, preferably manganese oxide particles having a diameter distributed between 40 μm and 2 mm are used. According to a particular compaction method, manganese oxide particles having a diameter less than or equal to 250 μm, preferably a diameter comprised between 40 μm and 250 μm, are used.

According to another embodiment the composition consists of a mixture of iron oxide only. Such a composition may be formed from a single type of iron oxide, or of several different types of iron oxide. The iron oxide(s) are for example selected from: FeO, Fe2O3, Fe3O4.

In this case, said iron oxide based composition in the form of a three-dimensional compacted tablet has an apparent density comprised between 2 and 5, and preferably between 2.8 and 4.4. To form such a tablet, preferably iron oxide particles having a diameter distributed between 15 μm and 1 mm, preferably between 15 μm and 500 μm, are used. According to a particular compaction method, iron oxide particles having a diameter less than or equal to 50 μm are used.

According to yet another embodiment, the composition consists of a mixture of manganese oxide (of one or more types of manganese oxide) with one or more other types of metal oxide, where the metal is selected from poor metals and transition metals, preferably with the exclusion of chromium. Preferably, the manganese oxide(s) are in the majority in the composition (that is to say greater than 50% by weight), more preferably greater than 70% by weight.

According to yet another embodiment, the composition consists of a mixture of iron oxide (of one or more types of iron oxide) with one or more other types of metal oxide, where the metal is selected from poor metals and transition metals, preferably with the exclusion of chromium. Preferably, the iron oxide(s) are in the majority in the composition (that is to say greater than 50% by weight), more preferably greater than 70% by weight.

Moreover, the compacted tablet has preferably a homogeneous density distribution within the tablet. The compaction method proposed using a uniaxial press makes it possible in fact to form tablets where the density is substantially the same along the longitudinal direction (that is to say along the longitudinal axis of movement of the punches) and along the transversal direction (that is to say perpendicular to the longitudinal axis of movement of the punches).

A small density gradient may exist along the longitudinal direction notably when only one of the punches is in movement with respect to the other, the highest density being located on the side of the active punch, and the lowest density being located on the opposite side where the punch is inactive.

Whatever the case, the differences in density along the longitudinal direction are very small, at the most 0.2 for example for compounds that are not very compressible (type Fe3O4), and preferably at the most 0.05 for example for highly compressible compounds (type MnO).

The compacted tablet moreover preferably has a diametral breaking strength greater than or equal to 250 kPa, preferably greater than 350 kPa, more preferentially greater than 500 kPa.

To determine the diametral breaking strength, the hardness of the tablet is measured along the largest dimension of the tablet (often the diameter for a substantially cylindrical tablet). To do so, a diametral force is applied up to breakage of the tablet. A DR. SCHLEUNIGER 8M type hardness tester is used to carry out these hardness measurements. This breaking force is converted into pressure in order to be able to disregard the dimension of the pastilles. The diametral breaking strength is calculated by the formula: Rd (kPa)=2000* breaking force (in N) divided by the area of the crown under load (in mm²).

The compacted tablet moreover has a certain volume facilitating its handling. Preferably, it has a volume greater than or equal to 350 mm3.

In an advantageous form of embodiment, the tablets have a regular shape, for example selected from the group of parallelepiped cylinders, and have a diameter of 10 mm to 100 mm. Preferably, the diameter is greater than or equal to 15 mm, more preferably greater than or equal to 20 mm. Preferentially the diameter is less than or equal to 70 mm, preferably less than or equal to 50 mm.

The tablet preferably has a height comprised between a value equal to one third of the diameter and a value equal to the diameter. Preferably the height of the tablet is equal to half of the diameter of the tablet.

For example it is possible to provide a tablet having a height of 3 mm for a diameter of 10 mm, ora tablet having a height of 16 mm fora diameter of 32 mm.

According to an embodiment, the compacted tablets have an average mass per compact of at least 3 g, preferably of at least 5 g, preferentially of at least 10 g. In a preferred embodiment, the compacts have nevertheless an average mass per tablet less than or equal to 200 g, preferably less than or equal to 150 g, preferentially less than or equal to 100 g, and in particular less than or equal to 50 g.

Advantageously, the compacted tablets have an apparent porosity comprised between 3% and 40%, preferentially between 5% and 30%, and more preferably less than or equal to 25%.

The apparent porosity of a tablet corresponds to the ratio between the volume not occupied by the solid material (the pores) and the total volume of the tablet, that is to say the apparent volume.

The apparent porosity results from the difference between the theoretical density (called true density) of the material to be compacted and its real density in the final product, that is to say the apparent density. It is calculated in the following manner:

Apparent porosity=1−(apparent density of the compact/theoretical density of the material to be compacted).

Numerous properties (mechanical, thermal, electrical, etc.) depend on the level of porosity and on the size and the distribution of pores. It is thus important to be able to quantify these parameters.

The porosity range of the compacted tablets described makes it possible to improve their mechanical properties as well as their ageing resistance. In fact, low porosity makes it possible on the one hand to make the pastille denser, which is in favor of better mechanical properties, and, on the other hand, to reduce exchanges between the pastille and the exterior environment (humidity and oxygen from the air) and thus to favor better conservation of the pastilles (to limit surface oxidation and hydration reactions).

The quality of the compacted tablet formed may thus be evaluated by the “drop test”. Drop test resistance is taken to mean the mass percentage of particles having an average diameter below 10 mm, generated at the outcome of 2 drops of 2 m starting with 5 kg of compacted product and falling onto a PVC plate. The tablets compacted according to the method implemented have a drop test resistance less than 15%, preferably less than 10%.

The compacted tablets produced are exempt of macro-defects such as fissures, cracks or cleavage planes unlike products in the form of briquettes and analogues which contain fissures from several hundreds of micrometers to several millimeters long for a width of several micrometers to several hundreds of micrometers which can be easily highlighted by simple visual observation, with an optical microscope or instead a scanning electron microscope (SEM).

Advantageously, the mechanical properties of the tablets are not degraded over time or remain compatible with the application.

To form, from metal oxide particles, such a compacted tablet, consisting only of a mixture of metal oxides, that is to say without other compounds, a rotary punch press operating at high compaction pressures is used.

In principle, the compaction system includes a rotating plate having cavities forming matrices inside of which one or two punches can slide, these elements forming a confinement space in which the composition is placed for compaction.

It is the action of the punches that exerts the compaction stress necessary for the formation of the compact. This compaction stress applied may consist in taking the composition to a determined compaction pressure and potentially maintaining said compaction pressure during a determined compaction time. It may also be sought to take the composition to a determined compaction volume and potentially maintaining it at this determined volume for a certain time.

The geometry and the operation of a rotary press enables better transmission of stress on the product to be compacted, which brings about better homogenization of the density distribution in the compact and thus better mechanical strength and fewer structural defects.

Furthermore, the proposed compaction method using a rotary press makes it possible to compact metal oxide particles having a random particle size distribution.

It is in fact possible to compact metal oxide particles having a wide particle size distribution, compared to methods of the prior art where the particle size distribution of the particles to be compacted is centered on a particular particle size value. Particle size distribution is taken to mean a distribution in which the ratio between the equivalent diameters of particles of larger size and smaller size is greater than 50 and in which the appearance of the distribution of the particle size brackets constituting it can vary considerably.

The proposed manufacturing method includes the following successive steps:
E1. Taking a composition consisting of a mixture of one or more metal oxides in the form of particles;
E2. Placing said composition in a confined space between two punches;
E3. Compaction of said composition by bringing together the punches and exerting a compaction stress on the composition in order to form a three-dimensional compacted tablet;
E4. Relaxation of the compaction stress by moving apart the punches.

As specified above, the compaction stress may consist in applying a determined compaction pressure on the composition. To form compacted tablets having the required properties, the compaction pressure is for example comprised between 100 MPa and 800 MPa, preferably comprised between 200 MPa and 650 MPa, more preferentially comprised between 300 MPa and 500 MPa, and even more preferentially comprised between 350 MPa and 450 MPa.

Such a pressure is preferably applied in an instantaneous manner.

The compaction stress may also consist in maintaining the composition at a determined compaction volume for a determined time. Preferably, the compaction volume is maintained at a determined volume for a duration comprised between 100 ms and 5000 ms, and more typically comprised between 500 ms and 1000 ms.

According to a particular embodiment, the compaction method is adapted to form a compacted multilayer product, that is to say comprising several different layers, where each layer consists of a mixture of one or more metal oxides being in the form of a compacted tablet.

To do so, each layer forming the multilayer structure may for example be formed by carrying out successively steps E1, E2, E3 and E4, where each new layer is formed on the tablet compacted at the preceding step.

More precisely, the manufacture of such a compacted multilayer product may be achieved by carrying out the following successive steps:
A first layer is formed by carrying out steps E1, E2, E3 and E4 with a first composition consisting of a mixture of one or more metal oxides to create a first compacted tablet;
An additional layer is formed by carrying out steps E1, E2, E3 and E4 where:
   At step E1, an additional composition is taken consisting of a mixture of one or more metal oxides;
   At step E2, the additional composition is placed in the confined space between two punches on the first compacted tablet;
   At step E3, the additional composition and the first compacted tablet are compacted by bringing together the punches and exerting a compaction stress on the composition in order to form an additional compacted tablet on the first compacted tablet;
The formation of an additional layer is reiterated as a function of the number of layers desired in the compacted multilayer product.

The proposed manufacturing method has the advantage of creating compacted multilayer products having several juxtaposed and directly accessible layers.

The use of a rotary press to form the compacted metal oxide based products enables better control of the kinetic and the kinematic of compaction with the possibility of pre-packing and/or pre-compaction making it possible to better densify the powder and to expel air thus avoiding the formation of defects such as cleavage or capping.

Moreover, it offers the possibility of external lubrication, that is to say lubrication of the punches and matrices, which is more economical (typically 0.01% of lubricant instead of the 0.25% to 1% of lubricant normally used in the powder). This moreover avoids adding additional compounds to the composition to be compacted, which can denature said composition.

Once the compacted product has been formed having a single layer or several layers, at step E5 the compacted product is ejected outside of the confined space.

The method according to the present invention may further comprise an additional step E6 consisting of a heat treatment of the compacted tablet or the compacted multilayer product, at a constant temperature comprised between 900° C. and 1400° C., for several minutes to several hours.

The proposed manufacturing method is particularly advantageous for the following reasons:
the compacted tablet formed has sufficient density to be used in metallurgical applications, such as for example in converters;
the compacted tablet formed has sufficient physical integrity so that the product can be handled and stored without being degraded, or while having minimum losses;
the method is simple, notably in that the number of steps to form the final product from the recovery of the base metal oxide compounds is reduced to the minimum.

The compacted product thereby formed being constituted only of compounds of metal oxides, it may be used in numerous industrial applications. It may thus be used in applications in the iron and steel industry, but also in the treatment of flue gases, in the treatment of water, in the treatment of sludge and waste water, in agriculture, in construction and in civil engineering.

Table 1 hereafter gives a certain number of examples of realization where compacted tablets containing a metal oxide have been manufactured according to the compaction method described.

The sample to be compacted, in the form of a mixture of particles, was loaded in a matrix and compacted with the aid of a uniaxial press manufactured by Eurotab Technologie according to the characteristics described in Table 1. The matrix had a diameter of 16 mm, and the punches had a flat compaction surface, thereby forming tablets of cylindrical shape. The indicated particle size corresponds to the maximum size of the metal oxide particles used.

The characteristics of the tablets obtained after compaction are also given in Table 1.

The diametral hardness is measured on a Dr. Schleuniger hardness tester. A force is applied diametrally up to breakage of the compact. This breakage force is converted into pressure in order to be able to disregard the dimension of the pastilles.

The diametral strength is calculated by the formula: Rd (kPa)=2000*breaking force (in N) divided by the area of the crown under load (in mm²).

The drop test was carried out as described above.

TABLE 1

| | | Test n°1 | Test n°2 | Test n°3 | Test n°4 | Test n°5 |
|---|---|---|---|---|---|---|
| Characteristics | Type of metal | MnO | MnO | MnO | Fe3O4 | Fe3O4 |
| of the sample to | oxide | | | | | |
| be compacted | Particle size | <250 μm | <250 μm | <250 μm | <50 μm | <50 μm |
| | (μm) | | | | | |
| Compaction | Compacted | 4.5 | 4.5 | 4.5 | 8.6 | 8.6 |
| characteristics | mass (g) | | | | | |
| | Height of the | 7.6 | 6.85 | 5.94 | 11.3 | 11.3 |
| | tablet (mm) | | | | | |
| | Punch | 150 | 150 | 150 | 30 | 30 |
| | approach speed | | | | | |
| | (mm/s) | | | | | |
| | Time(s) of | 0 | 0 | 0 | 0 | 5 |
| | maintaining at | | | | | |
| | constant | | | | | |
| | volume | | | | | |
| | Compaction | 144 | 288 | 587 | 730 | 730 |
| | pressure (Mpa) | | | | | |
| Characteristics | Apparent | 2.95 | 3.26 | 3.77 | 3.8 | 3.81 |
| of the | density | | | | | |
| compacted | Diametral | 128 | 379 | >800 | 52 | 78 |
| tablet | hardness (N) | | | | | |
| | Diametral | 671 | 2200 | >5360 | 178 | 276 |
| | strength (kPa) | | | | | |
| | Drop test | 5% | <3% | <3% | Not | 14% |
| | | | | | measured | |

Comparative tests were also carried out to highlight the differences between products compacted in the form of briquettes produced according to methods of the prior art, notably by a tangent roller press, and tablets compacted according to the proposed method.

Table 2 hereafter summaries these additional tests.

The briquette formed by this method has an ellipsoid shape, with a length of around 25 mm, a width of around 15 mm, and a thickness of around 8 mm.

The tangent roller press used for the tests is the micro-compactor MP1 150/30 with granulator SC 100 sold by the firm SAHUT CONREUR.

The briquettes were produced according to a speed of rotation of the rollers of around 20 rpm (+/−5 rpm to try to obtain the “best looking” briquettes possible) and a pre-compactor speed of around 100 rpm (+/−20 rpm as a function of the level of raw material in the reservoir), with a power supplied by the motor corresponding to a maximum amperage of 3.4 A.

TABLE 2

| | | Test n°6 | Test n° 7 |
|---|---|---|---|
| Characteristics of | Type of metal oxide | MnO | Fe3O4 |
| the sample to be | Particle size (μm) | <250 μm | <50 μm |
| compacted | Compacted mass (g) | 9 | 8.9 |
| Compaction | Pre-compactor speed | 100 | 100 |
| characteristics | (rpm) | (+/−20) | (+/−20) |
| | Wheel rotation speed | 20 | 20 |
| | (rpm) | (+/−5) | (+/−5) |
| | Linear compaction force | 75 | 75 |
| | (kN) | | |
| | Maintaining time (s) | 0 | 0 |
| Briquette | Apparent density | 2.83 | 3.1 |
| characteristics | Diametral hardness (N) | 90 | 65 |
| | Diametral strength (kPa) | 180 | 176 |
| | Drop test | 60% | 90% |

Tables 1 and 2 show that the tablets compacted according to the proposed method have characteristics, notably in terms of hardness, strength and drop test resistance, far superior to those of briquettes of same composition but formed with methods of the prior art.

Furthermore, the proposed method has the advantage of being able to be easily adapted to modify these final characteristics of the compacted product. By comparing tests n°4 and n°5, it may in fact be noted that it suffices to maintain the compaction volume at a constant volume for several seconds to produce a compacted tablet according to the required characteristics.

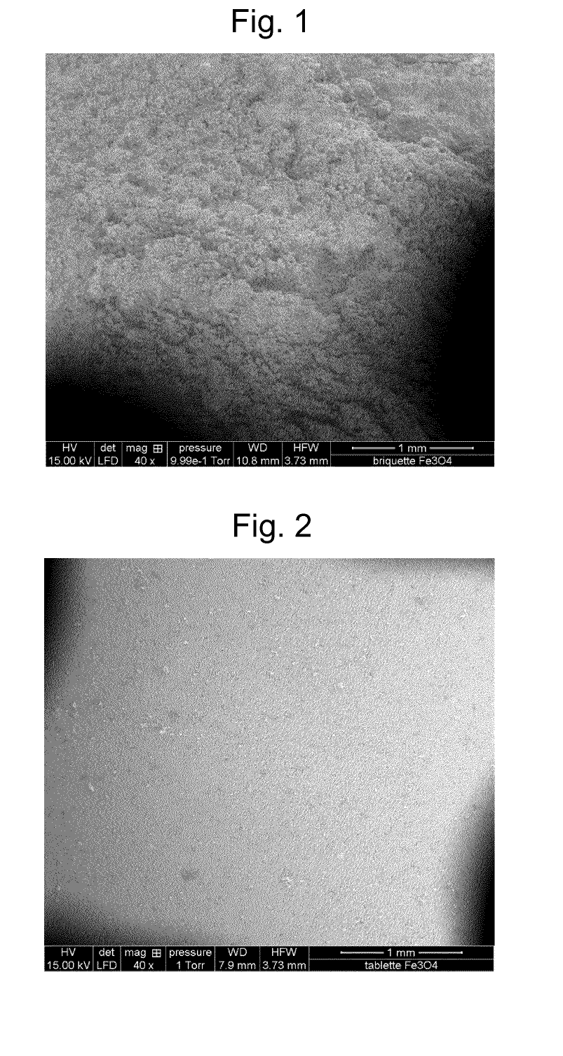

The SEM (acronym for “Scanning Electron Microscopy”) images of FIGS. 1 to 10 also make it possible to characterize the structural differences between briquettes formed by methods of the prior art and compacted products formed with the proposed method.

FIGS. 1 and 2 are SEM images of the surface of a briquette and of a compacted tablet respectively, based on Fe3O4. It may be noted that the surface of the compacted tablet is much smoother and has fewer surface defects than the briquette.

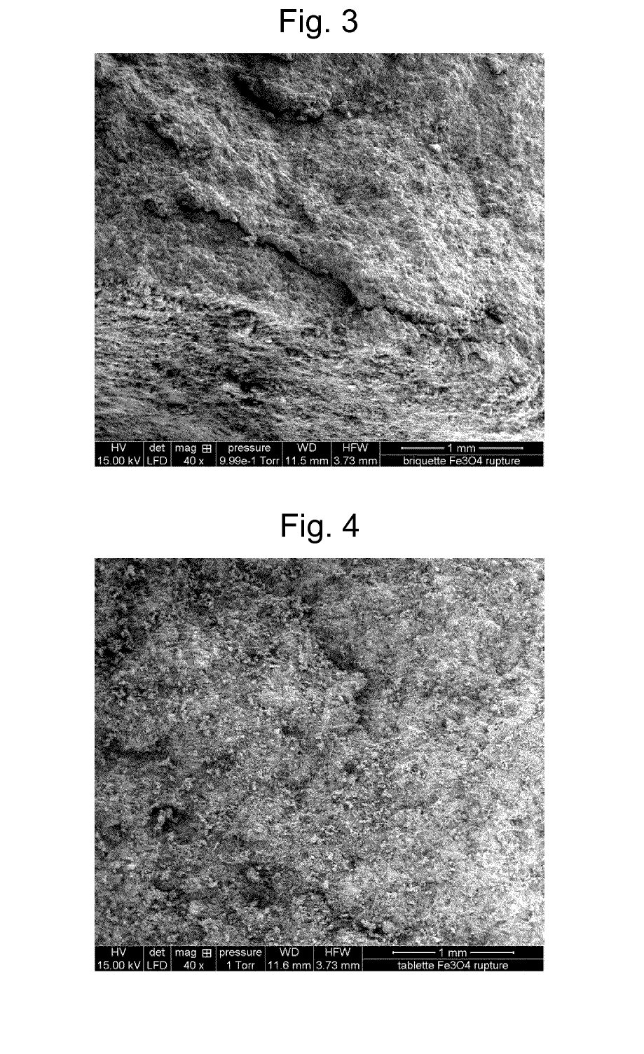

FIGS. 3 and 4 are SEM images illustrating the interior of this briquette and this compacted tablet respectively, based on Fe3O4, according to an enlargement of 40 times. It is apparent that the compacted tablet has better structural homogeneity. Moreover, it may be noted that there are structural defects inside the briquette, illustrated notably by the apparent fracture faces.

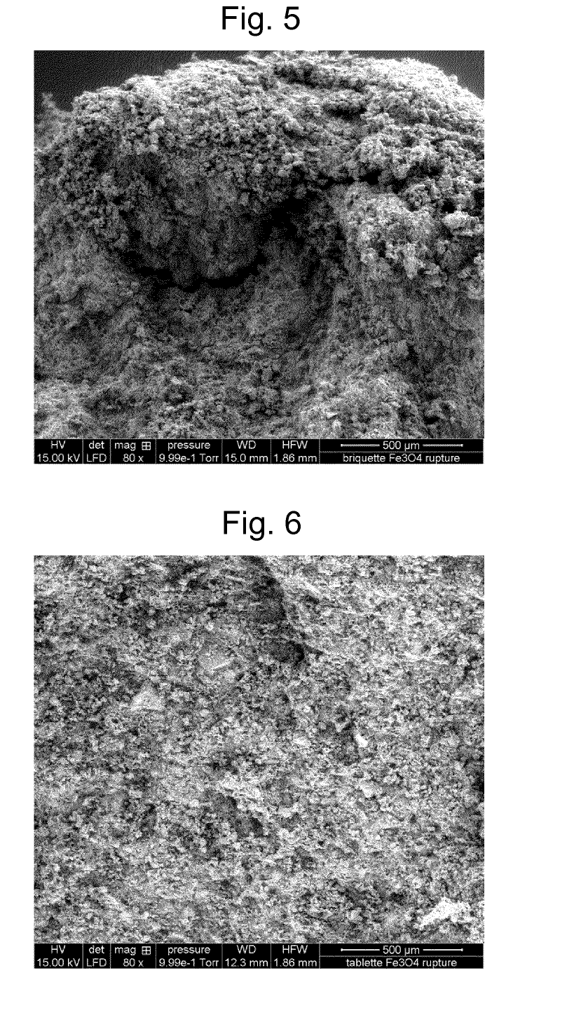

FIGS. 5 and 6, which are also SEM images illustrating the interior of the briquette and this compacted tablet respectively, based on Fe3O4, but according to an enlargement of 80 times, confirm these structural differences. In fact, whereas the compacted tablet still has a very homogeneous and uniform structure, it may be seen that the structure of the briquette is very disordered, with numerous defects.

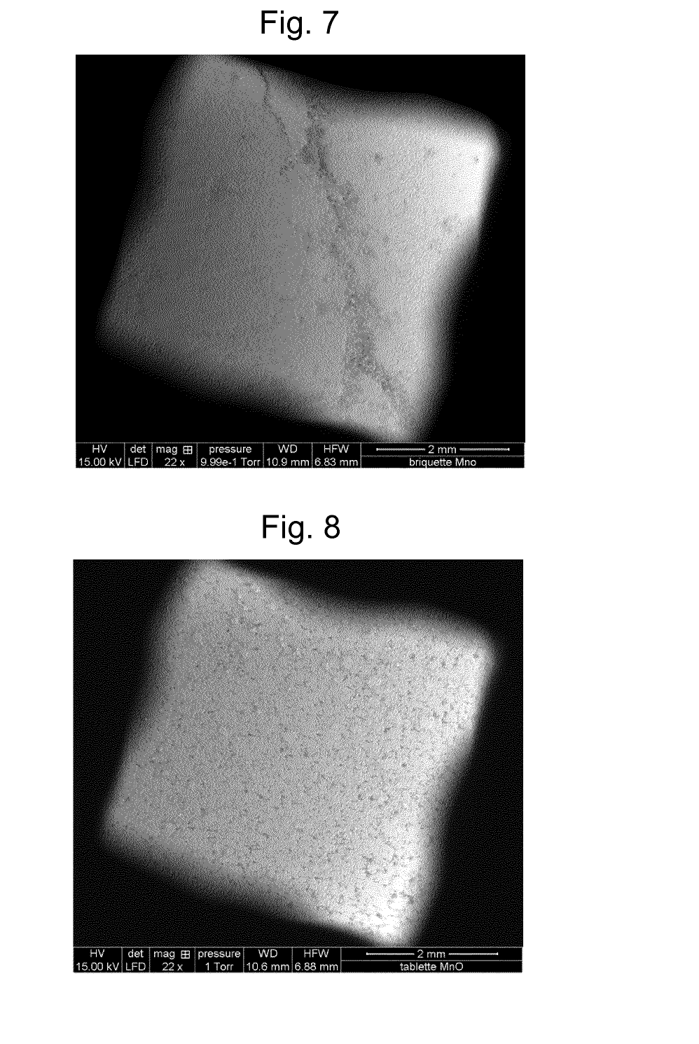

The SEM images of FIGS. 7 and 8, which illustrate for their part the surface of a briquette and a compacted tablet respectively, based on MnO, make it possible to draw the same conclusions as previously. In fact, it may be noted that the surface of the briquette of MnO has important surface defects whereas the compacted tablet of MnO has a homogeneous surface, without any noticeable real defects.

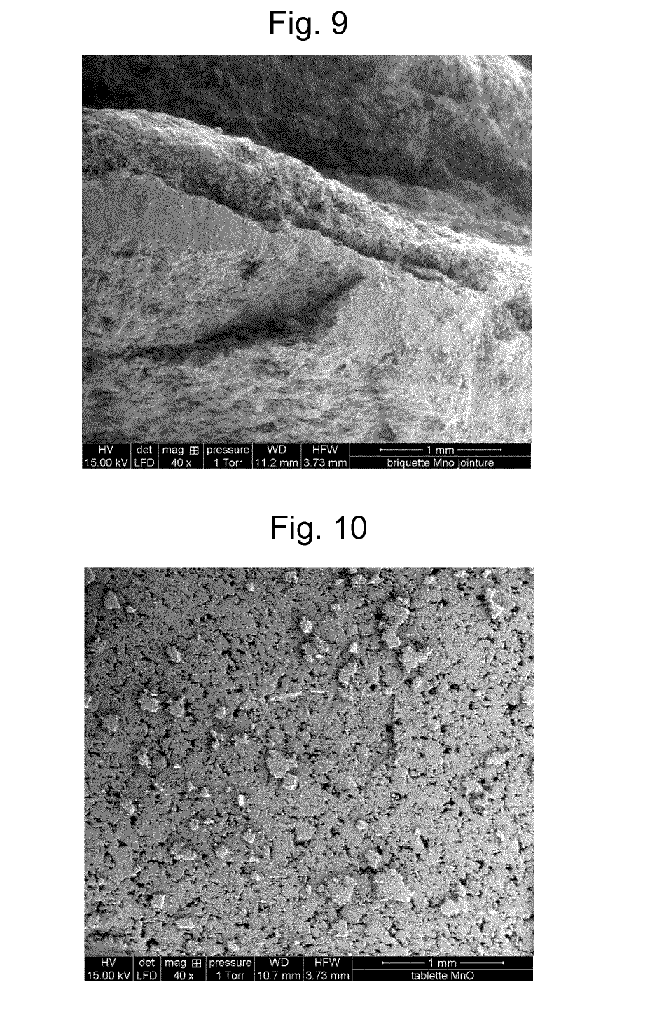

Furthermore, the SEM images of FIGS. 9 and 10 illustrating the interior of this briquette and this compacted tablet respectively, based on MnO, according to an enlargement of 40 times, also show that the internal structure of the compacted tablet is homogeneous and uniform whereas the briquette of MnO includes important structural defects.

### BIBLIOGRAPHIC REFERENCES

U.S. Pat. No. 4,917,723

EP 2 298 941

DE 24 18 555

DE 24 31 983

EP 0 466 160

1. Composition consisting of a mixture of one or more metal oxides of formula MxOyUi, in which M is a metal atom selected from iron, aluminum, titanium, manganese, zinc, copper, zirconium, nickel and lead, O is an oxygen atom, and U is an impurity, where x, y, i are mole fractions comprised between 0 and 1 with x+y>80%, said composition taking the form of a three-dimensional compacted tablet having an apparent density greater than or equal to 2, an apparent porosity comprised between 3% and 40%, and a diametral breaking strength greater than or equal to 250 kPa.

2. The composition of claim 1, in which the metal oxides are in the form of particles having a diameter d90 less than or equal to 3 mm.

3. The composition of claim 1, in which the metal oxides are in the form of particles having diameters according to a random particle size distribution in which the ratio between the equivalent diameters of particles of largest size and smallest size is greater than 50.

4. The composition of claim 1 formed of a single type of metal oxide.

5. The composition of claim 1, consisting of a mixture of iron oxide, a mixture of aluminum oxide, a mixture of titanium oxide, a mixture of manganese oxide, a mixture of zinc oxide, a mixture of copper oxide, a mixture of zirconium oxide, a mixture of lead oxide, or a mixture of at least two of the metal oxides cited above.

6. The composition of claim 1, consisting of a mixture of manganese oxide only, said composition taking the form of a three-dimensional compacted tablet having an apparent density comprised between 2 and 5.

7. The composition of claim 1, consisting of a mixture of iron oxide only, said composition taking the form of a three-dimensional compacted tablet having an apparent density comprised between 2 and 5.

8. The composition of claim 1, consisting of a mixture of manganese oxide in a quantity greater than 50% by weight with a mixture of one or more other types of metal oxide.

9. The composition of claim 1, consisting of a mixture of iron oxide in a quantity greater than 50% by weight with a mixture of one or more other types of metal oxide.

10. The composition of claim 1, having a drop test resistance less than 15%, preferably less than 10%, and more preferably less than 5%.

11. The composition of claim 1, where the compacted tablet has an apparent porosity comprised between 5% and 30%.

12. The composition of claim 1, where the compacted tablet has an apparent porosity comprised between 10% and 25%.

13. Compacted product having a multilayer structure, where each layer forming the multilayer structure is a three-dimensional compacted tablet having an apparent density greater than or equal to 2, an apparent porosity comprised between 3% and 40%, and a diametral breaking strength greater than or equal to 250 kPa, wherein the composition of said compacted tablet consists of a mixture of one or more metal oxides of formula MxOyUi, in which M is a metal atom selected from iron, aluminum, titanium, manganese, zinc, copper, zirconium, nickel and lead, O is an oxygen atom, and U is an impurity, where x, y, i are mole fractions comprised between 0 and 1 with x+y>80%.

14. Method of manufacturing a compacted tablet based on one or more metal oxides with a rotary punch press, including the following steps:
E1. Taking a composition consisting of a mixture of one or more metal oxides of formula MxOyUi, in which M is a metal atom selected from iron, aluminum, titanium, manganese, zinc, copper, zirconium, nickel and lead, O is an oxygen atom, and U is an impurity, where x, y, i are mole fractions comprised between 0 and 1 with x+y>80%;
E2. Placing said composition in a confined space between two punches;
E3. Compaction of said composition by bringing together the punches and exerting a compaction stress on the composition in order to form a three-dimensional compacted tablet;
E4. Relaxation of the compaction stress by moving apart the punches;

15. The method of claim 14, in which at step E1, a composition is taken consisting of a mixture of manganese oxide only.

16. The method of claim 14, in which at step E1, a composition is taken consisting of a mixture of iron oxide only.

17. The method of claim 14, in which at step E3 of compaction, the compaction stress consists in applying a determined compaction pressure on the composition, the compaction pressure being comprised between 100 MPa and 800 MPa, preferably comprised between 200 MPa and 650 MPa, even more preferentially comprised between 300 MPa and 500 MPa, and in an even more preferential manner comprised between 350 MPa and 450 MPa.

18. The method of claim 14, in which at step E3 of compaction, the compaction stress consists in maintaining the composition at a determined compaction volume for a determined duration, the compaction volume being maintained for a duration comprised between 100 ms and 5000 ms, and preferably comprised between 500 ms and 1000 ms.

19. The method of claim 14, in which the metal oxide particles of step E1 are taken directly from industrial metal oxide wastes without prior treatment.

20. The method of claim 14, in which at step E1, a composition is taken including particles of a single type of metal oxide.

21. The method of claim 14, in which the metal oxide particles of step E1 are in the form of particles having a random particle size distribution.

22. The method of claim 14, in which the metal oxide particles of step E1 have diameters such that the ratio between the equivalent diameters of particles of largest size and smallest size is greater than 50.

23. The method of claim 14, in which the metal oxide particles of step E1 are in the form of particles having a diameter d90 less than or equal to 3 mm.

24. Method for manufacturing a compacted product having a multilayer structure, in which each layer forming the multilayer structure is formed by carrying out successively the following formation steps:,
E1. Taking a composition consisting of a mixture of one or more metal oxides of formula MxOyUi, in which M is a metal atom selected from iron, aluminum, titanium, manganese, zinc copper, zirconium, nickel and lead, O is an oxygen atom, and U is an impurity, where x, y, i are mole fractions comprised between 0 and 1 with x+y>80%
E2. Placing said composition in a confined space between two punches;
E3. Compaction of said composition by bringing together the punches and exerting a compaction stress on the composition in order to form a three-dimensional compacted tablet;
E4. Relaxation of the compaction stress by moving apart the punches;

25. Method according to claim 24, in which:
A first layer is formed by carrying out steps E1, E2, E3 and E4 with a first composition to create a first compacted tablet;
An additional layer is formed by carrying out steps E1, E2, E3 and E4 where:
At step E1, an additional composition is taken consisting of a mixture of one or more metal oxides;
At step E2, the additional composition is placed in the confined space between two punches on the first compacted tablet;
At step E3, the additional composition and the first compacted tablet are compacted by bringing together punches and exerting a compaction stress on the composition in order to form an additional compacted tablet on the first compacted tablet;
The formation of an additional layer is reiterated as a function of the number of layers desired in the compacted multilayer product.

26. Composition consisting of a mixture of one or more metal oxides of formula MxOyUi, in which M is a metal atom selected from poor metals and transition metals with the exclusion of chromium, O is an oxygen atom, and U is an impurity, where x, y, i are mole fractions comprised between 0 and 1 with x+y>80%, said composition taking the form of a three-dimensional compacted tablet having an apparent density greater than or equal to 2, an apparent porosity comprised between 3% and 40%, and a diametral breaking strength greater than or equal to 250 kPa.
